(19) United States
(12) Patent Application Publication
(10) Pub. No.: US 2020/0070827 A1
(43) Pub. Date: Mar. 5, 2020

(54) AUTONOMOUS VEHICLE AND OPERATING METHOD FOR AUTONOMOUS VEHICLE

(71) Applicant: LG Electronics Inc., Seoul (KR)

(72) Inventor: Heedong CHOI, Seoul (KR)

(21) Appl. No.: 16/463,234

(22) PCT Filed: May 8, 2017
(86) PCT No.: PCT/KR2017/004761

§ 371 Date: May 22, 2019

(30) Foreign Application Priority Data
Nov. 22, 2016 (KR) 10-2016-0155954

(51) Int. Cl. B60W 30/12; B60W 30/14; G05D 1/00

(52) U.S. Cl. CPC B60W 30/12; B60W 2050/0077; G05D 1/0061; B60W 30/14

(57) ABSTRACT

The present invention relates to an autonomous vehicle comprising: a communication device configured to generate communication intensity information when communicating with an external device; and a controller configured to control the vehicle to drive based on the communication intensity information.

### TECHNICAL FIELD

The present invention relates to an autonomous vehicle and an operating method for autonomous vehicle.

### BACKGROUND ART

A vehicle is an apparatus that moves in a direction desired by a user riding therein. A representative example of a vehicle is an automobile.

Meanwhile, a variety of sensors and electronic devices are provided for convenience of a user who uses the vehicle. In particular, for driving convenience of user, an Advanced Driver Assistance System (ADAS) has been actively studied. In addition, development of autonomous vehicles has been vigorously accomplished.

The autonomous vehicle may be operated based on a V2X communication. A communication device included in the autonomous vehicle may receive information, signal, or data from nearby vehicle or an infrastructure (e.g., Intelligent Transport Systems (ITS)), and may be driven based on the received information, signal, or data.

In this case, the communication state between the autonomous driving vehicle and the nearby vehicle, and the communication state between the autonomous driving vehicle and the infrastructure are important factors. However, the autonomous driving vehicle according to the related art is operated without considering the communication state, so that the communication may be disconnected during driving. In addition, there is a risk of an accident due to the disconnection of the communication.

### DISCLOSURE

### Technical Problem

The present invention has been made in view of the above problems, and it is an object of the present invention is to provide an autonomous vehicle that drives based on communication intensity information.

It is another object of the present invention to provide a method of operating an autonomous vehicle that drives based on communication intensity information.

The problems of the present invention are not limited to the above-mentioned problems, and other problems not mentioned can be clearly understood by those skilled in the art from the following description.

### Technical Solution

In order to achieve the above object, an autonomous vehicle according to an embodiment of the present invention includes: a communication device configured to generate communication intensity information when communicating with an external device; and a controller configured to control the vehicle to drive based on the communication intensity information.

In order to achieve the above object, an operating method for an autonomous vehicle according to an embodiment of the present invention includes: acquiring communication intensity information through a communication device, when communicating with an external device; generating a map in which communication intensity is matched for each lane and section, based on the communication intensity information; deciding a driving lane by using a lane and a section that have a relatively large communication intensity; and outputting the map and information on decided driving lane through a user interface apparatus.

The details of embodiments are included in the detailed description and drawings.

### Advantageous Effects

According to an embodiment of the present invention, there is one or more of the following effects.

First, since vehicle drives based on communication intensity information, there is an effect that no damage due to the disconnection of the communication during the driving is generated.

Second, it is possible to select whether vehicle drives on a lane or route having a good communication state by user selection, thereby improving user convenience.

Thirdly, since information on the communication state is outputted through a user interface, there is an effect that user can check the communication state and cope with it appropriately.

The effects of the present invention are not limited to the effects mentioned above, and other effects not mentioned may be clearly understood by those skilled in the art from the description of the claims.

### DESCRIPTION OF DRAWINGS

FIG. 1 is a diagram illustrating the external appearance of a vehicle according to an embodiment of the present invention.

FIG. 2 is different angled views of the external appearance of a vehicle according to an embodiment of the present invention.

FIGS. 3 and 4 are diagrams illustrating the interior configuration of a vehicle according to an embodiment of the present invention.

FIGS. 5 and 6 are diagrams illustrating an object according to an embodiment of the present invention.

FIG. 7 is a block diagram illustrating a vehicle according to an embodiment of the present invention.

FIG. 8 is a flowchart for explaining the operation of an autonomous vehicle according to an embodiment of the present invention.

FIGS. 9 to 12 are diagrams for explaining the operation of acquiring communication intensity information according to an embodiment of the present invention.

FIGS. 13 to 14C are diagrams for explaining the operation of controlling a vehicle to drive based on communication intensity information according to an embodiment of the present invention.

FIGS. 15 to 18 are diagrams for explaining the operation of controlling a vehicle to drive based on communication intensity information according to an embodiment of the present invention.

FIG. 19 is a diagram for explaining the operation of controlling a vehicle to drive based on an importance level of information according to an embodiment of the present invention.

FIG. 20 is a diagram for explaining an exceptional situation of driving based on communication intensity according to an embodiment of the present invention.

### MODE FOR INVENTION

Hereinafter, the embodiments disclosed in the present specification will be described in detail with reference to the accompanying drawings, and the same or similar elements are denoted by the same reference numerals even though they are depicted in different drawings and redundant descriptions thereof will be omitted. In the following description, with respect to constituent elements used in the following description, the suffixes “module” and “unit” are used or combined with each other only in consideration of ease in the preparation of the specification, and do not have or serve as different meanings. Accordingly, the suffixes “module” and “unit” may be interchanged with each other. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents and substitutions included in the scope and spirit of the present invention.

Although the terms “first,” “second,” etc., may be used herein to describe various components, these components should not be limited by these terms. These terms are only used to distinguish one component from another component. When a component is referred to as being “connected to” or “coupled to” another component, it may be directly connected to or coupled to another component or intervening components may be present. In contrast, when a component is referred to as being “directly connected to” or “directly coupled to” another component, there are no intervening components present.

As used herein, the singular form is intended to include the plural forms as well, unless the context clearly indicates otherwise. In the present application, it will be further understood that the terms “comprises”, includes,” etc. specify the presence of stated features, integers, steps, operations, elements, components, or combinations thereof, but do not preclude the presence or addition of one or more other features, integers, steps, operations, elements, components, or combinations thereof.

A vehicle as described in this specification may include an automobile and a motorcycle. Hereinafter, a description will be given based on an automobile.

A vehicle as described in this specification may include all of an internal combustion engine vehicle including an engine as a power source, a hybrid vehicle including both an engine and an electric motor as a power source, and an electric vehicle including an electric motor as a power source.

In the following description, “the left side of the vehicle” refers to the left side in the driving direction of the vehicle, and “the right side of the vehicle” refers to the right side in the driving direction of the vehicle.

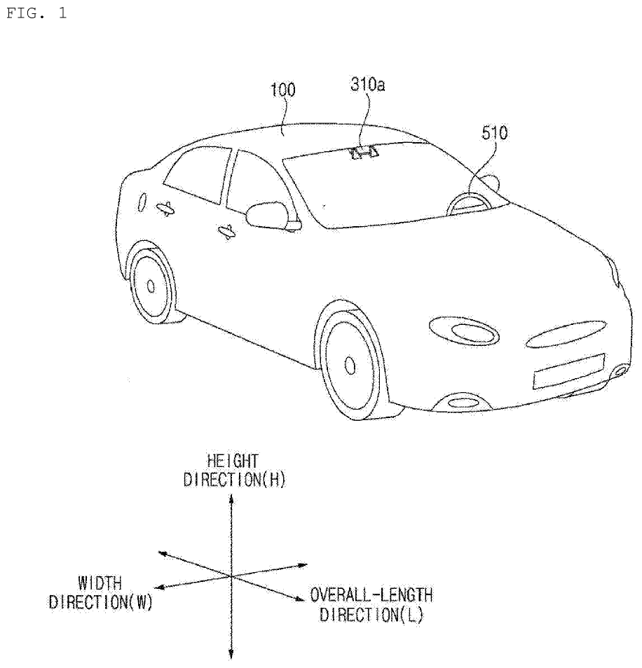

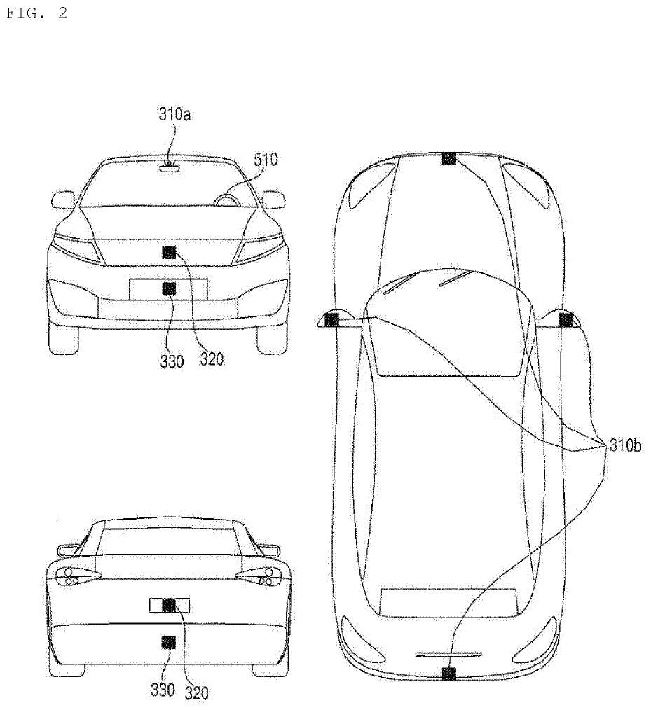

FIG. 1 is a diagram illustrating the external appearance of a vehicle according to an embodiment of the present invention.

FIG. 2 is different angled views of the external appearance of a vehicle according to an embodiment of the present invention.

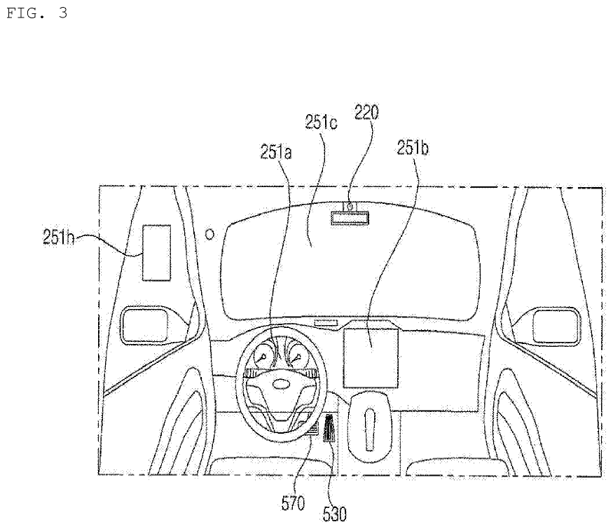

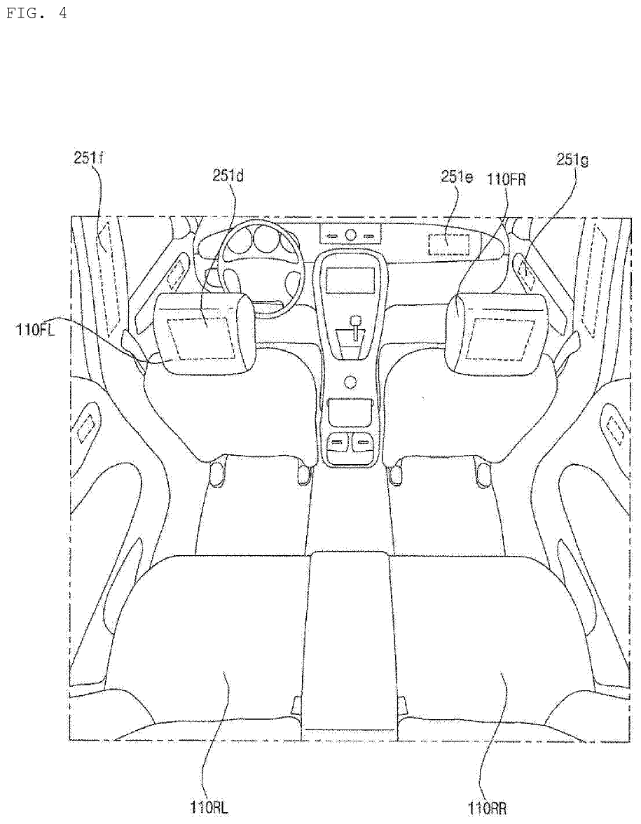

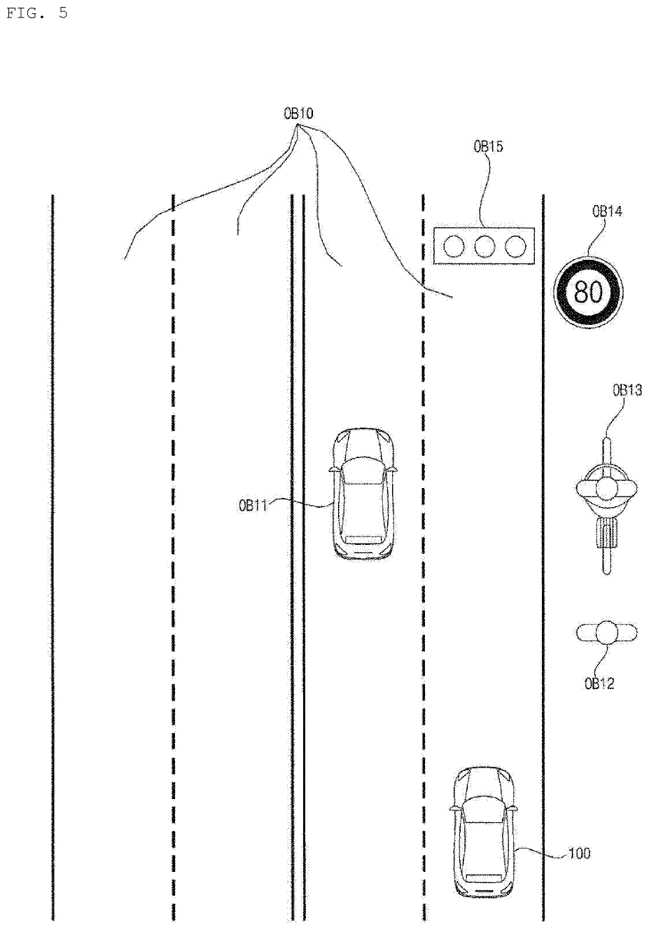

FIGS. 3 and 4 are diagrams illustrating the interior configuration of a vehicle according to an embodiment of the present invention.

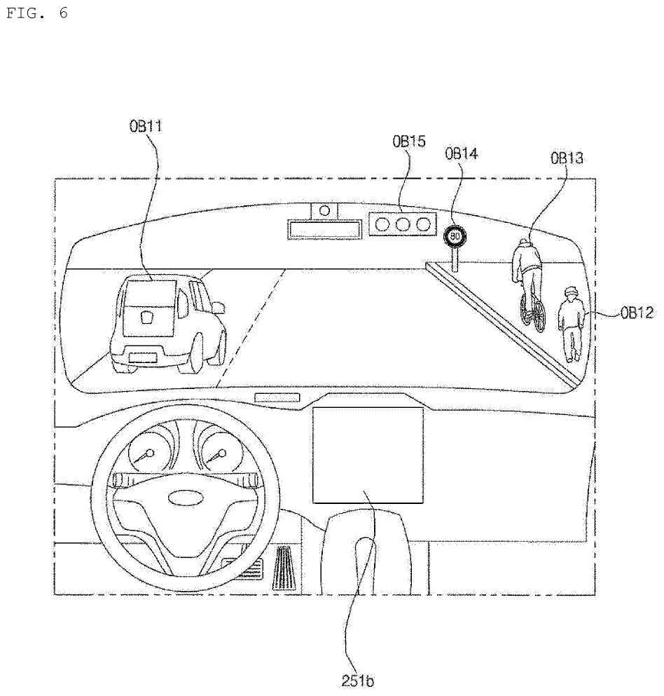

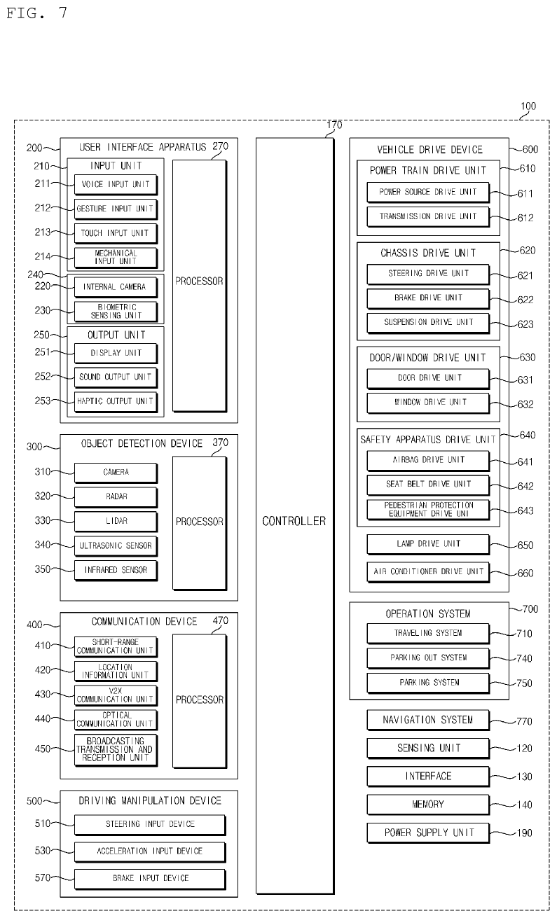

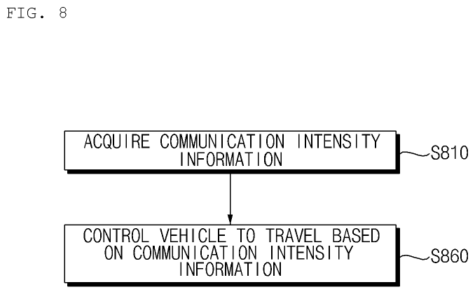

FIGS. 5 and 6 are diagrams illustrating an object according to an embodiment of the present invention.

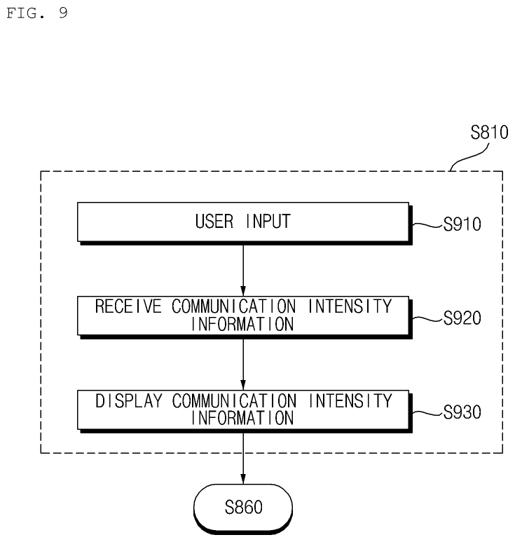

FIG. 7 is a block diagram illustrating a vehicle according to an embodiment of the present invention.

Referring to FIGS. 1 to 7, a vehicle 100 may include a wheel rotated by a power source, and a steering input device 510 for controlling a driving direction of the vehicle 100.

The vehicle 100 may be an autonomous vehicle.

The vehicle 100 may be switched to an autonomous driving mode or a manual driving mode, based on a user input.

For example, based on a user input received through a user interface apparatus 200, the vehicle 100 may be switched from a manual driving mode to an autonomous driving mode, or vice versa.

The vehicle 100 may also be switched to an autonomous driving mode or a manual driving mode based on driving state information.

The driving state information may include on at least one of information on an object outside the vehicle 100, navigation information, and vehicle condition information.

For example, the vehicle 100 may be switched from the manual driving mode to the autonomous driving mode, or vice versa, based on driving state information generated by the object detection device 300.

For example, the vehicle 100 may be switched from the manual driving mode to the autonomous driving mode, or vice versa, based on driving state information received through a communication device 400.

The vehicle 100 may be switched from the manual driving mode to the autonomous driving mode, or vice versa, based on information, data, and a signal provided from an external device.

When the vehicle 100 operates in the autonomous driving mode, the autonomous vehicle 100 may operate based on an operation system 700.

For example, the autonomous vehicle 100 may operate based on information, data, or signal generated by a driving system 710, a parking out system 740, and a parking system 750.

While operating in the manual driving mode, the autonomous vehicle 100 may receive a user input for driving of the vehicle 100 through a driving manipulation device 500. Based on the user input received through the driving manipulation device 500, the vehicle 100 may operate.

The term “overall length” means the length from the front end to the rear end of the vehicle 100, the term “width” means the width of the vehicle 100, and the term “height” means the length from the bottom of the wheel to the roof. In the following description, the term “overall length direction L” may mean the reference direction for the measurement of the overall length of the vehicle 100, the term “width direction W” may mean the reference direction for the measurement of the width of the vehicle 100, and the term “height direction H” may mean the reference direction for the measurement of the height of the vehicle 100.

As illustrated in FIG. 7, the vehicle 100 may include the user interface apparatus 200, the object detection device 300, the communication device 400, the driving manipulation device 500, a vehicle drive device 600, the operation system 700, a navigation system 770, a sensing unit 120, an interface 130, a memory 140, a controller 170, and a power supply unit 190.

In some embodiments, the vehicle 100 may further include other components in addition to the components mentioned in this specification, or may not include some of the mentioned components.

The user interface apparatus 200 is provided to support communication between the vehicle 100 and a user. The user interface apparatus 200 may receive a user input, and provide information generated in the vehicle 100 to the user. The vehicle 100 may implement User Interfaces (UI) or User Experience (UX) through the user interface apparatus 200.

The user interface apparatus 200 may include an input unit 210, an internal camera 220, a biometric sensing unit 230, an output unit 250, and a processor 270.

In some embodiments, the user interface apparatus 200 may further include other components in addition to the mentioned components, or may not include some of the mentioned components.

The input unit 210 is configured to receive information from a user, and data collected in the input unit 210 may be analyzed by the processor 270 and then processed by a control command of the user.

The input unit 210 may be disposed inside the vehicle 100. For example, the input unit 210 may be disposed in an area of a steering wheel, an area of an instrument panel, an area of a seat, an area of each pillar, an area of a door, an area of a center console, an area of a head lining, an area of a sun visor, an area of a windshield, or an area of a window.

The input unit 210 may include a voice input unit 211, a gesture input unit 212, a touch input unit 213, and a mechanical input unit 214.

The voice input unit 211 may convert a voice input of a user into an electrical signal. The converted electrical signal may be provided to the processor 270 or the controller 170.

The voice input unit 211 may include one or more microphones.

The gesture input unit 212 may convert a gesture input of a user into an electrical signal. The converted electrical signal may be provided to the processor 270 or the controller 170.

The gesture input unit 212 may include at least one of an infrared sensor and an image sensor for sensing a gesture input of a user.

According to an embodiment, the gesture input unit 212 may sense a three-dimensional (3D) gesture input of a user. To this end, the gesture input unit 212 may include a plurality of light emitting units for outputting infrared light, or a plurality of image sensors.

The gesture input unit 212 may sense the 3D gesture input by employing a Time of Flight (TOF) scheme, a structured light scheme, or a disparity scheme.

The touch input unit 213 may convert a user's touch input into an electrical signal, and the converted electrical signal may be provided to the processor 270 or the controller 170.

The touch input unit 213 may include a touch sensor for sensing a touch input of a user.

According to an embodiment, the touch input unit 210 may be integrally formed with a display unit 251 to implement a touch screen. Such a touch screen may provide an input interface and an output interface between the vehicle 100 and the user.

The mechanical input unit 214 may include at least one of a button, a dome switch, a jog wheel, and a jog switch. An electrical signal generated by the mechanical input unit 214 may be provided to the processor 270 or the controller 170.

The mechanical input unit 214 may be disposed on a steering wheel, a center fascia, a center console, a cockpit module, a door, etc.

The internal camera 220 may acquire images of the inside of the vehicle 100. The processor 270 may sense a user's state based on the images of the inside of the vehicle. The processor 270 may acquire information on an eye gaze of the user from the images of the inside of the vehicle. The processor 270 may sense a gesture of the user from the images of the inside of the vehicle.

The biometric sensing unit 230 may acquire biometric information of the user. The biometric sensing unit 230 may include a sensor for acquiring biometric information of the user, and may acquire finger print information, heartbeat information, and the like of the user by using the sensor. The biometric information may be used for user authentication.

The output unit 250 is configured to generate an output related to visual, auditory, or tactile sense.

The output unit 250 may include at least one of a display unit 251, a sound output unit 252, and a haptic output unit 253. The display unit 251 may display graphic objects corresponding to various types of information.

The display unit 251 may include at least one of a Liquid Crystal Display (LCD), a Thin Film Transistor-Liquid Crystal Display (TFT LCD), an Organic Light-Emitting Diode (OLED), a flexible display, a 3D display, and an e-ink display.

The display unit 251 may form a mutual layer structure together with the touch input unit 213, or may be integrally formed with the touch input unit 213 to implement a touch screen.

The display unit 251 may be implemented as a Head Up Display (HUD). When implemented as a HUD, the display unit 251 may include a projector module in order to output information through an image projected on a windshield or a window.

The display unit 251 may include a transparent display. The transparent display may be attached on the windshield or the window.

The transparent display may display a certain screen with a certain transparency. In order to achieve the transparency, the transparent display may include at least one of a transparent

Thin Film Electroluminescent (TFEL) display, an Organic Light Emitting Diode (OLED) display, a transparent Liquid Crystal Display (LCD), a transmissive transparent display, and a transparent Light Emitting Diode (LED) display. The transparency of the transparent display may be adjustable.

Meanwhile, the user interface apparatus 200 may include a plurality of display units 251a to 251g.

The display unit 251 may be disposed in an area of a steering wheel, an area 251a, 251b, or 251e of an instrument panel, an area 251d of a seat, an area 251f of each pillar, an area 251g of a door, an area of a center console, an area of a head lining, an area of a sun visor, an area 251c of a windshield, or an area 251h of a window.

The sound output unit 252 converts an electrical signal from the processor 270 or the controller 170 into an audio signal, and outputs the audio signal. To this end, the sound output unit 252 may include one or more speakers.

The haptic output unit 253 generates a tactile output. For example, the haptic output unit 253 may operate to vibrate a steering wheel, a safety belt, and seats 110FL, 110FR, 110RL, and 110RR so as to allow a user to recognize the output.

The processor 270 may control the overall operation of each unit of the user interface apparatus 200.

In some embodiments, the user interface apparatus 200 may include a plurality of processors 270 or may not include the processor 270.

When the user interface apparatus 200 does not include the processor 270, the user interface apparatus 200 may operate under the control of the controller 170 or a processor of other device inside the vehicle 100.

Meanwhile, the user interface apparatus 200 may be referred to as a display device for vehicle.

The user interface apparatus 200 may operate under the control of the controller 170.

The object detection device 300 is an apparatus for detecting an object disposed outside the vehicle 100. The object detection device 300 may generate object information based on sensing data.

The object information may include information related to existence of an object, location information of an object, information on a distance between the vehicle 10 and the object, and information on relative speed of the vehicle 100 and the object.

The object may be various objects related to driving of the vehicle 100.

Referring to FIGS. 5 and 6, an object o may include a lane OB10, a nearby vehicle OB11, a pedestrian OB12, a two-wheeled vehicle OB13, a traffic signal OB14 and OB15, a light, a road, a structure, a bump, a geographical feature, an animal, etc.

The lane OB10 may be a driving lane, a side lane of the driving lane, or a lane on which the opposed vehicle drives. The lane OB10 may be left and right lines that define the lane.

The nearby vehicle OB11 may be a vehicle that is driving in the vicinity of the vehicle 100. The nearby vehicle OB11 may be a vehicle within a certain distance from the vehicle 100. For example, the nearby vehicle OB11 may be a vehicle that is preceding or following the vehicle 100.

The pedestrian OB12 may be a person in the vicinity of the vehicle 100. The pedestrian OB12 may be a person within a certain distance from the vehicle 100. For example, the pedestrian OB12 may be a person on a sidewalk or on the roadway.

The two-wheeled vehicle OB13 may be a vehicle that is disposed in the vicinity of the vehicle 100 and moves by using two wheels. The two-wheeled vehicle OB13 may be a vehicle that has two wheels positioned within a certain distance from the vehicle 100. For example, the two-wheeled vehicle OB13 may be a motorcycle or a bike on a sidewalk or the roadway.

The traffic signal may include a traffic light OB15, a traffic sign plate OB14, and a pattern or text painted on a road surface.

The light may be light generated by a lamp provided in the nearby vehicle. The light may be light generated by a street lamp. The light may be solar light.

The road may include a road surface, a curve, and slopes, such as an upward slope and a downward slope.

The structure may be a body that is disposed around the road and is fixed onto the ground. For example, the structure may include a street lamp, a roadside tree, a building, a telephone pole, a traffic light, and a bridge.

The geographical feature may include a mountain and a hill. Meanwhile, the object may be classified into a movable object and a stationary object. For example, the movable object may include a nearby vehicle and a pedestrian. For example, the stationary object may include a traffic signal, a road, and a structure.

The object detection device 300 may include a camera 310, a radar 320, a lidar 330, an ultrasonic sensor 340, an infrared sensor 350, and a processor 370.

In some embodiments, the object detection device 300 may further include other components in addition to the mentioned components, or may not include some of the mentioned components.

The camera 310 may be disposed at an appropriate position outside the vehicle 100 in order to acquire images of the outside of the vehicle 100. The camera 310 may be a mono camera, a stereo camera 310a, an Around View Monitoring (AVM) camera 310b, or a 360-degree camera.

Further, the camera 310 may acquire location information of an object, information on a distance to the object, or information on a relative speed to the object, by using various image processing algorithms.

For example, the camera 310 may acquire the information on the distance to the object and information on the relative speed to the object, based on change over time in size of the object, from the acquired image.

For example, the camera 310 may acquire the information on the distance to the object and information on the relative speed to the object, by using a pin hole model or profiling a road surface.

For example, the camera 310 may acquire the information on the distance to the object and the information on the relative speed to the object, based on information on disparity, from stereo image acquired by a stereo camera 310a.

For example, the camera 310 may be disposed near a front windshield in the vehicle 100 in order to acquire images of the front of the vehicle 100. Alternatively, the camera 310 may be disposed around a front bumper or a radiator grill.

For example, the camera 310 may be disposed near a rear glass in the vehicle 100 in order to acquire images of the rear of the vehicle 100. Alternatively, the camera 310 may be disposed around a rear bumper, a trunk, or a tailgate.

For example, the camera 310 may be disposed near at least one of the side windows in the vehicle 100 in order to acquire images of the lateral side of the vehicle 100. Alternatively, the camera 310 may be disposed around a side mirror, a fender, or a door.

The camera 310 may provide an acquired image to the processor 370.

The radar 320 may include an electromagnetic wave transmission unit and an electromagnetic wave reception unit. The radar 320 may be implemented by a pulse radar scheme or a continuous wave radar scheme depending on the principle of emission of an electronic wave. The radar 320 may be implemented by a Frequency Modulated Continuous Wave (FMCW) scheme or a Frequency Shift Keying (FSK) scheme depending on the waveform of a signal.

The radar 320 may detect an object by using an electromagnetic wave as medium based on a time of flight (TOF) scheme or a phase-shift scheme, and may detect a position of the detected object, the distance to the detected object, and the relative speed to the detected object.

The radar 320 may be disposed at an appropriate position outside the vehicle 100 in order to detect an object disposed in front of the vehicle 100, in the rear side of the vehicle 100, or in the lateral side of the vehicle 100.

The lidar 330 may include a laser transmission unit and a laser reception unit. The lidar 330 may be implemented by the Time of Flight (TOF) scheme or the phase-shift scheme.

The lidar 330 may be implemented as a drive type lidar or a non-drive type lidar. When implemented as the drive type lidar, the lidar 300 may rotate by a motor and detect an object in the vicinity of the vehicle 100.

When implemented as the non-drive type lidar, the lidar 300 may detect an object disposed within a certain range based on the vehicle 100, due to a light steering. The vehicle 100 may include a plurality of non-drive type lidars 330.

The lidar 330 may detect an object through the medium of laser light by employing the TOF scheme or the phase-shift scheme, and may detect a position of the detected object, the distance to the detected object, and the relative speed to the detected object.

The lidar 330 may be disposed at an appropriate position outside the vehicle 100 in order to detect an object disposed in front of the vehicle 100, disposed in the rear side of the vehicle 100, or in the lateral side of the vehicle 100.

The ultrasonic sensor 340 may include an ultrasonic wave transmission unit and an ultrasonic wave reception unit. The ultrasonic sensor 340 may detect an object based on an ultrasonic wave, and may detect a position of the detected object, the distance to the detected object, and the relative speed to the detected object.

The ultrasonic sensor 340 may be disposed at an appropriate position outside the vehicle 100 in order to detect an object disposed in front of the vehicle 100, disposed in the rear side of the vehicle 100, or in the lateral side of the vehicle 100.

The infrared sensor 350 may include an infrared light transmission unit and an infrared light reception unit. The infrared sensor 350 may detect an object based on infrared light, and may detect a position of the detected object, the distance to the detected object, and the relative speed to the detected object.

The infrared sensor 350 may be disposed at an appropriate position outside the vehicle 100 in order to detect an object disposed in front of the vehicle 100, disposed in the rear side of the vehicle 100, or in the lateral side of the vehicle 100.

The processor 370 may control the overall operation of each unit of the object detection device 300.

The processor 370 may detect and classify an object by comparing data sensed by the camera 310, the radar 320, the lidar 330, the ultrasonic sensor 340, and the infrared sensor 350 with pre-stored data.

The processor 370 may detect and track an object based on acquired images. The processor 370 may calculate the distance to the object, the relative speed to the object, and the like by using image processing algorithms.

For example, the processor 370 may acquire information on the distance to the object and information on the relative speed to the object, based on change over time in size of the object, from the acquired image.

For example, the processor 370 may acquire information on the distance to the object or information on the relative speed to the object by employing a pin hole model or by profiling a road surface.

For example, the processor 370 may acquire information on the distance to the object and information on the relative speed to the object based on information on disparity from the stereo image acquired by the stereo camera 310a.

The processor 370 may detect and track an object, based on a reflection electromagnetic wave which is formed as a transmitted electromagnetic wave is reflected by the object and returned. Based on the electromagnetic wave, the processor 370 may calculate the distance to the object, the relative speed to the object, and the like.

The processor 370 may detect and track an object based on a reflection laser light which is formed as a transmitted laser light is reflected by the object and returned. Based on the laser light, the processor 370 may calculate the distance to the object, the relative speed to the object, and the like.

The processor 370 may detect and track an object based on a reflection ultrasonic wave which is formed as a transmitted ultrasonic wave is reflected by the object and returned. Based on the ultrasonic wave, the processor 370 may calculate the distance to the object, the relative speed to the object, and the like.

The processor 370 may detect and track an object based on reflection infrared light which is formed as a transmitted infrared light is reflected by the object and returned. Based on the infrared light, the processor 370 may calculate the distance to the object, the relative speed to the object, and the like.

In some embodiments, the object detection device 300 may include a plurality of processors 370 or may not include the processor 370. For example, each of the camera 310, the radar 320, the lidar 330, the ultrasonic sensor 340, and the infrared sensor 350 may include its own processor individually.

When the object detection device 300 does not include the processor 370, the object detection device 300 may operate under the control of the controller 170 or a processor inside the vehicle 100.

The object detection device 300 may operate under the control of the controller 170.

The communication device 400 is an apparatus for performing communication with an external device. Here, the external device may be a nearby vehicle, a mobile terminal, or a server.

In order to perform communication, the communication device 400 may include at least one of a transmission antenna, a reception antenna, a Radio Frequency (RF) circuit capable of implementing various communication protocols, and an RF device.

The communication device 400 may include a short-range communication unit 410, a location information unit 420, a V2X communication unit 430, an optical communication unit 440, a broadcasting transmission and reception unit 450, an Intelligent Transport Systems (ITS) communication unit 460, and a processor 470.

In some embodiments, the communication device 400 may further include other components in addition to the mentioned components, or may not include some of the mentioned components.

The short-range communication unit 410 is configured to perform short-range communication. The short-range communication unit 410 may support short-range communication by using at least one of Bluetooth™, Radio Frequency IDdentification (RFID), Infrared Data Association (IrDA), Ultra-WideBand (UWB), ZigBee, Near Field Communication (NFC), Wireless-Fidelity (Wi-Fi), Wi-Fi Direct, and Wireless Universal Serial Bus (Wireless USB).

The short-range communication unit 410 may form wireless area networks to perform short-range communication between the vehicle 100 and at least one external device.

The location information unit 420 is a unit for acquiring location information of the vehicle 100. For example, the location information unit 420 may include a Global Positioning System (GPS) module or a Differential Global Positioning System (DGPS) module.

The V2X communication unit 430 is a unit for performing wireless communication with a server (vehicle to infra (V2I) communication), a nearby vehicle (vehicle to vehicle (V2V) communication), or a pedestrian (vehicle to pedestrian (V2P) communication). The V2X communication unit 430 may include an RF circuit capable of implementing protocols for a communication with the infra (V2I), an inter-vehicle communication (V2V), and a communication with the pedestrian (V2P).

The optical communication unit 440 is a unit for performing communication with an external device by using light as medium. The optical communication unit 440 may include a light emitting unit, which converts an electrical signal into an optical signal and transmits the optical signal to the outside, and a light reception unit which converts a received optical signal into an electrical signal.

In some embodiments, the light emitting unit may be integrally formed with a lamp included in the vehicle 100.

The broadcasting transmission and reception unit 450 is a unit for receiving a broadcast signal from an external broadcasting management server or transmitting a broadcast signal to the broadcasting management server through a broadcasting channel. The broadcasting channel may include a satellite channel, and a terrestrial channel. The broadcast signal may include a TV broadcast signal, a radio broadcast signal, and a data broadcast signal.

The ITS communication unit 460 may exchange information, data, or signals with a traffic system. The ITS communication unit 460 may provide acquired information or data to the traffic system. The ITS communication unit 460 may receive information, data, or signals from the traffic system. For example, the ITS communication unit 460 may receive traffic information from the traffic system and provide the traffic information to the controller 170. For example, the ITS communication unit 460 may receive a control signal from the traffic system, and provide the control signal to the controller 170 or a processor provided in the vehicle 100.

The processor 470 may control the overall operation of each unit of the communication device 400.

In some embodiments, the communication device 400 may include a plurality of processors 470, or may not include the processor 470.

When the communication device 400 does not include the processor 470, the communication device 400 may operate under the control of the controller 170 or a processor of other device inside of the vehicle 100.

In addition, the communication device 400 may implement a vehicle display device, together with the user interface apparatus 200. In this case, the vehicle display device may be referred to as a telematics device or an Audio Video Navigation (AVN) device.

The communication device 400 may operate under the control of the controller 170.

The driving manipulation device 500 is configured to receive a user input for driving.

In the case of manual driving mode, the vehicle 100 may operate based on a signal provided by the driving manipulation device 500.

The driving manipulation device 500 may include a steering input device 510, an acceleration input device 530, and a brake input device 570.

The steering input device 510 may receive an input of driving direction of the vehicle 100 from a user. It is preferable that the steering input device 510 is implemented in a form of a wheel to achieve a steering input through a rotation. According to an embodiment, the steering input device may be implemented in a form of a touch screen, a touch pad, or a button.

The acceleration input device 530 may receive an input for acceleration of the vehicle 100 from a user. The brake input device 570 may receive an input for deceleration of the vehicle 100 from a user. It is preferable that the acceleration input device 530 and the brake input device 570 are implemented in the form of a pedal. According to an embodiment, the acceleration input device or the brake input device may be implemented in the form of a touch screen, a touch pad, or a button.

The driving manipulation device 500 may operate under the control of the controller 170.

The vehicle drive device 600 is configured to electrically control the operation of various devices of the vehicle 100.

The vehicle drive device 600 may include a power train drive unit 610, a chassis drive unit 620, a door/window drive unit 630, a safety apparatus drive unit 640, a lamp drive unit 650, and an air conditioner drive unit 660.

In some embodiments, the vehicle drive device 600 may further include other components in addition to the mentioned components, or may not include some of the mentioned components.

In addition, the vehicle drive device 600 may include a processor. Each unit of the vehicle drive device 600 may include its own processor individually.

The power train drive unit 610 may control the operation of a power train apparatus.

The power train drive unit 610 may include a power source drive unit 611 and a transmission drive unit 612.

The power source drive unit 611 may control a power source of the vehicle 100.

For example, when a fossil fuel-based engine is the power source, the power source drive unit 611 may perform electronic control of the engine. Thus, the output torque of the engine can be controlled. The power source drive unit 611 may adjust the output toque of the engine under the control of the controller 170.

For example, when an electric motor is the power source, the power source drive unit 611 may control the motor. The power source drive unit 610 may adjust the RPM, toque, and the like of the motor under the control of the controller 170. The transmission drive unit 612 may control a transmission. The transmission drive unit 612 may adjust the state of the transmission.

The transmission drive unit 612 may adjust a state of the transmission. The transmission drive unit 612 may adjust a state of the transmission to a drive (D), reverse (R), neutral (N), or park (P) state.

Meanwhile, when an engine is the power source, the transmission drive unit 612 may adjust a gear-engaged state, in the drive D state.

The chassis drive unit 620 may control the operation of a chassis

The chassis drive unit 620 may include a steering drive unit 621, a brake drive unit 622, and a suspension drive unit 623.

The steering drive unit 621 may perform electronic control of a steering apparatus provided inside the vehicle 100. The steering drive unit 621 may change the driving direction of the vehicle 100.

The brake drive unit 622 may perform electronic control of a brake apparatus provided inside the vehicle 100. For example, the brake drive unit 622 may reduce the speed of the vehicle 100 by controlling the operation of a brake disposed in a wheel.

Meanwhile, the brake drive unit 622 may control a plurality of brakes individually. The brake drive unit 622 may control the braking forces applied to the plurality of wheels to be different from each other.

The suspension drive unit 623 may perform electronic control of a suspension apparatus inside the vehicle 100. For example, when the road surface is uneven, the suspension drive unit 623 may control the suspension apparatus so as to reduce the vibration of the vehicle 100.

Meanwhile, the suspension drive unit 623 may control a plurality of suspensions individually.

The door/window drive unit 630 may perform electronic control of a door apparatus or a window apparatus inside the vehicle 100.

The door/window drive unit 630 may include a door drive unit 631 and a window drive unit 632.

The door drive unit 631 may control the door apparatus, and control opening or closing of a plurality of doors included in the vehicle 100. The door drive unit 631 may control opening or closing of a trunk or a tail gate. The door drive unit 631 may control opening or closing of a sunroof.

The window drive unit 632 may perform electronic control of the window apparatus and control opening or closing of a plurality of windows included in the vehicle 100.

The safety apparatus drive unit 640 may perform electronic control of various safety apparatuses provided inside the vehicle 100

The safety apparatus drive unit 640 may include an airbag drive unit 641, a seat belt drive unit 642, and a pedestrian protection equipment drive unit 643.

The airbag drive unit 641 may perform electronic control of an airbag apparatus inside the vehicle 100. For example, upon detection of a dangerous situation, the airbag drive unit 641 may control an airbag to be deployed.

The seat belt drive unit 642 may perform electronic control of a seatbelt apparatus inside the vehicle 100. For example, upon detection of a dangerous situation, the seat belt drive unit 642 may control passengers to be fixed onto seats 110FL, 110FR, 110RL, and 110RR by using a safety belt.

The pedestrian protection equipment drive unit 643 may perform electronic control of a hood lift and a pedestrian airbag. For example, upon detection of a collision with a pedestrian, the pedestrian protection equipment drive unit 643 may control the hood lift to be lifted up and the pedestrian airbag to be deployed.

The lamp drive unit 650 may perform electronic control of various lamp apparatuses provided inside the vehicle 100.

The air conditioner drive unit 660 can perform electronic control of an air conditioner inside the vehicle 100. For example, when the inner temperature of the vehicle 100 is high, the air conditioner drive unit 660 may operate the air conditioner to supply cool air to the inside of the vehicle.

In addition, the vehicle drive device 600 may include a processor. Each unit of the vehicle dive device 600 may include its own processor individually. The vehicle drive device 600 may operate under the control of the controller 170.

The operation system 700 is a system for controlling various operations of the vehicle 100. The operation system 700 may operate in the autonomous driving mode.

The operation system 700 may include the driving system 710, the parking out system 740, and the parking system 750.

In some embodiments, the operation system 700 may further include other components in addition to the mentioned components, or may not include some of the mentioned component.

Meanwhile, the operation system 700 may include a processor. Each unit of the operation system 700 may include its own processor.

Meanwhile, according to an embodiment, when the operation system 700 is implemented in software, it may be a subordinate concept of the controller 170.

In some embodiments, the operation system 700 may include at least one of the user interface apparatus 200, the object detection device 300, the communication device 400, the driving manipulation device 500, the vehicle drive device 600, the navigation system 770, and the sensing unit 120, and the controller 170.

The driving system 710 may perform driving of the vehicle 100. The driving system 710 may perform driving of the vehicle 100, by receiving navigation information from the navigation system 770 and providing a control signal to the vehicle drive device 600.

The driving system 710 may perform driving of the vehicle 100, by receiving object information from the object detection device 300, and providing a control signal to the vehicle drive device 600.

The driving system 710 may perform driving of the vehicle 100, by receiving a signal from an external device through the communication device 400 and providing a control signal to the vehicle drive device 600.

The driving system 710 may include at least one of the user interface apparatus 270, the object detection device 300, the communication device 400, the driving manipulation device 500, the vehicle drive device 600, the navigation system 770, the sensing unit 120, and the controller to perform driving of the vehicle 100.

Such a driving system 710 may be referred to as a vehicle driving control apparatus.

The parking-out system 740 may perform the parking-out of the vehicle 100.

The parking-out system 740 may move the vehicle 100 out of a parking space, by receiving navigation information from the navigation system 770 and providing a control signal to the vehicle drive device 600.

The parking-out system 740 may move the vehicle 100 out of a parking space, by receiving object information from the object detection device 300 and providing a control signal to the vehicle drive device 600.

The parking-out system 740 may move the vehicle 100 out of a parking space, by receiving a signal from an external device and providing a control signal to the vehicle drive device 600.

The parking-out system 740 may include at least one of the user interface apparatus 270, the object detection device 300, the communication device 400, the driving manipulation device 500, the vehicle drive device 600, the navigation system 770, the sensing unit 120, and the controller 170 to move the vehicle 100 out of a parking space. Such a parking-out system 740 may be referred to as a vehicle parking-out control apparatus.

The parking system 750 may park the vehicle 100.

The parking system 750 may park the vehicle 100, by receiving navigation information from the navigation system 770 and providing a control signal to the vehicle drive device 600.

The parking system 750 may park the vehicle 100, by receiving object information from the object detection device 300 and providing a control signal to the vehicle drive device 600.

The parking system 750 may park the vehicle 100, by receiving a signal from an external device through the communication device 400, and providing a control signal to the vehicle drive device 600.

The parking system 750 may include at least one of the user interface apparatus 270, the object detection device 300, the communication device 400, the driving manipulation device 500, the vehicle drive device 600, the navigation system 770, the sensing unit 120, and the controller 170 to park the vehicle 100 in a parking space.

Such a parking system 750 may be referred to as a vehicle parking control apparatus.

The navigation system 770 may provide navigation information.

The navigation system 770 may include at least one of map information, information on set destination, path information due to the set destination, information on various objects on the path, lane information, and information on the current position of vehicle.

The navigation system 770 may include a memory and a processor. The memory may store navigation information. The processor may control the operation of the navigation system 770.

In some embodiments, the navigation system 770 may also update pre-stored information by receiving information from an external device through the communication device 400.

In some embodiments, the navigation system 770 may be classified as an element of the user interface apparatus 200.

The sensing unit 120 may sense the condition of the vehicle. The sensing unit 120 may include an attitude sensor (e.g., a yaw sensor, a roll sensor, a pitch sensor), a collision sensor, a wheel sensor, a speed sensor, a tilt sensor, a weight sensor, a heading sensor, a gyro sensor, a position module, a vehicle forward/reverse movement sensor, a battery sensor, a fuel sensor, a tire sensor, a steering sensor based on the rotation of the steering wheel, an in-vehicle temperature sensor, an in-vehicle humidity sensor, an ultrasonic sensor, an illumination sensor, an accelerator pedal position sensor, a brake pedal position sensor, and the like.

The sensing unit 120 may also acquire sensing signals related to vehicle attitude information, vehicle collision information, vehicle direction information, vehicle location information (GPS information), vehicle angle information, vehicle speed information, vehicle acceleration information, vehicle tilt information, vehicle forward/reverse movement information, battery information, fuel information, tire information, vehicle lamp information, in-vehicle temperature information, in-vehicle humidity information, steering-wheel rotation angle information, vehicle external illumination information, information on the pressure applied to accelerator pedal, information on the pressure applied to brake pedal, and the like.

The sensing unit 120 may further include an accelerator pedal sensor, a pressure sensor, an engine speed sensor, an Air Flow-rate Sensor (AFS), an Air Temperature Sensor (ATS), a Water Temperature Sensor (WTS), a Throttle Position Sensor (TPS), a Top Dead Center (TDC) sensor, a Crank Angle Sensor (CAS), and the like.

The sensing unit 120 may generate vehicle condition information based on sensing data. The vehicle condition information may be information that is generated based on data sensed by a variety of sensors provided inside a vehicle.

For example, the vehicle condition information may include vehicle posture information, vehicle speed information, vehicle tilt information, vehicle weight information, vehicle direction information, vehicle battery information, vehicle fuel information, vehicle tire pressure information, vehicle steering information, in-vehicle temperature information, in-vehicle humidity information, pedal position information, vehicle engine temperature information, etc.

The interface 130 may serve as a passage for various types of external devices that are connected to the vehicle 100. For example, the interface 130 may have a port that is connectable to a mobile terminal and may be connected to the mobile terminal via the port. In this case, the interface 130 may exchange data with the mobile terminal.

Meanwhile, the interface 130 may serve as a passage for the supply of electrical energy to a mobile terminal connected thereto. When the mobile terminal is electrically connected to the interface 130, the interface 130 may provide electrical energy, supplied from the power supply unit 190, to the mobile terminal under the control of the controller 170.

The memory 140 is electrically connected to the controller 170. The memory 140 may store basic data for each unit, control data for the operation control of each unit, and input/output data. The memory 140 may be various storage devices, in hardware, such as a ROM, a RAM, an EPROM, a flash drive, a hard drive, and the like. The memory 140 may store various data for the overall operation of the vehicle 100, such as programs for the processing or control of the controller 170.

According to an embodiment, the memory 140 may be integrally formed with the controller 170, or may be provided as an element of the controller 170.

The controller 170 may control the overall operation of each unit inside the vehicle 100. The controller 170 may be referred to as an Electronic Controller (ECU).

The power supply unit 190 may supply power required to operate each component under the control of the controller 170. In particular, the power supply unit 190 may receive power from a battery or the like inside the vehicle 100.

At least one processor and the controller 170 included in the vehicle 100 may be implemented by using at least one of Application Specific Integrated Circuits (ASICs), Digital Signal Processors (DSPs), Digital Signal Processing Devices (DSPDs),

Programmable Logic Devices (PLDs), Field Programmable Gate Arrays (FPGAs), processors, controllers, micro-controllers, microprocessors, and electric units for the implementation of other functions.

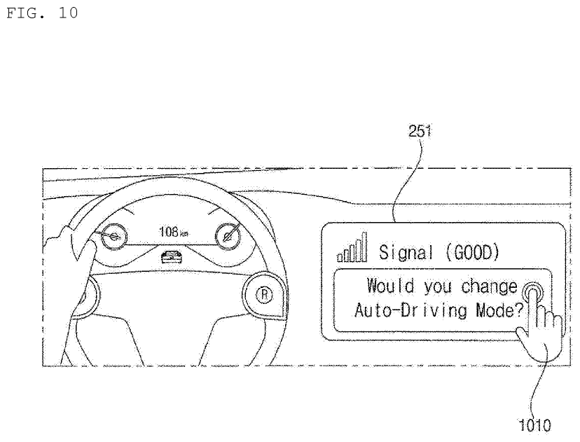

FIG. 8 is a flowchart for explaining the operation of an autonomous vehicle according to an embodiment of the present invention.

Referring to FIG. 8, the controller 170 may acquire communication intensity information (S810).

The communication device 400 may generate communication intensity information when communicating with an external device.

The communication device 400 may receive communication intensity information from the external device. The communication intensity information may be received from the external device via the communication device 400.

Here, the external device may be nearby vehicle or an infrastructure.

Here, the communication intensity information may include communication sensitivity or Received Signal Strength Intensity/Indication (RSSI). The communication intensity may be expressed numerically.

The controller 170 may output the communication intensity information through the user interface apparatus 200. The user interface apparatus 200 may output the communication intensity information.

The controller 170 may control the vehicle drive device 600 to drive the vehicle based on the communication intensity information (S860).

The controller 170 may receive communication intensity information from the communication device 400.

The controller 170 may control the vehicle 100 to drive based on the communication intensity information.

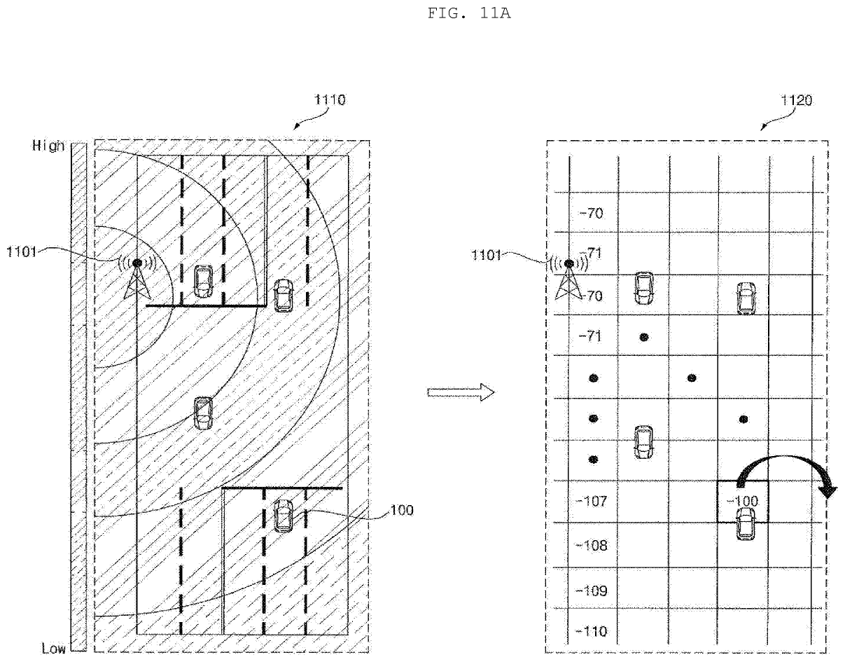

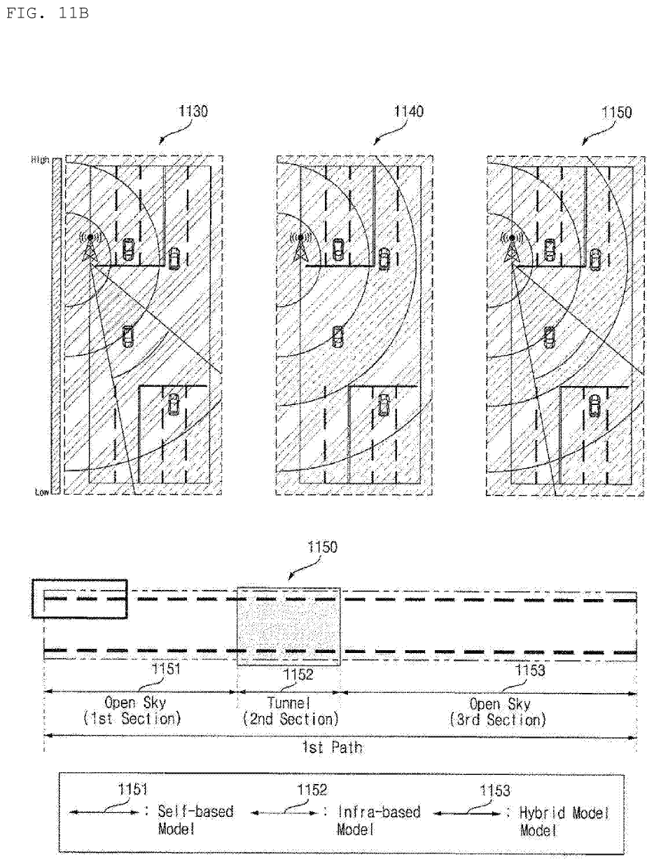

FIGS. 9 to 12 are diagrams for explaining the operation of acquiring communication intensity information according to an embodiment of the present invention.

Referring to FIG. 9, the controller 170 may receive a user input for driving based on the communication intensity information through the user interface apparatus 200 (S910).

The user interface apparatus 200 may receive the user input for driving based on the communication intensity information.

When the user input of vehicle driving mode selection based on the communication intensity information is received via the user interface apparatus 200, the controller 170 may control the vehicle to drive based on the communication intensity information.

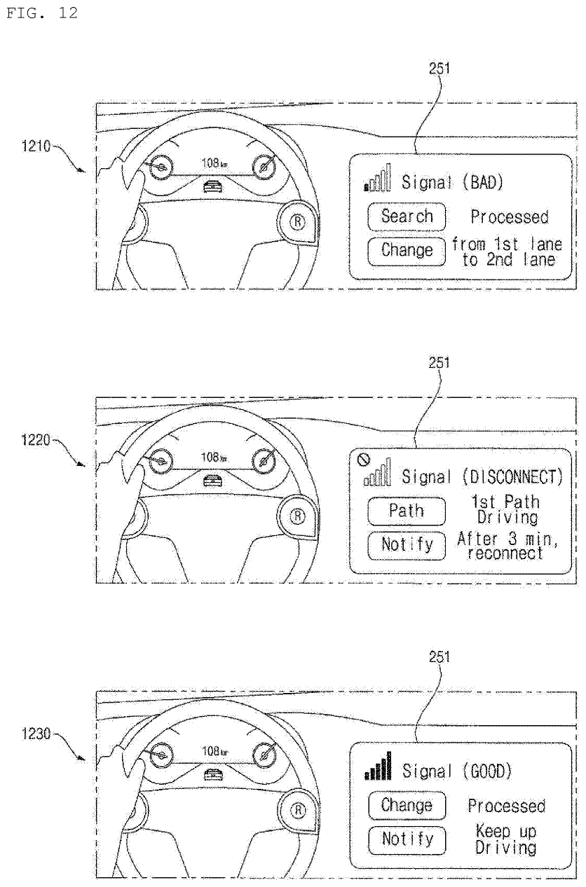

As illustrated in FIG. 10, the input unit 310 of the user interface apparatus 200 may receive user input.

Here, the user input may be a user input for selecting a driving based on the communication intensity information.

Here, the driving based on the communication intensity information may be a kind of an autonomous driving mode.

FIG. 10 illustrates that the input unit 310 receives a user input through a touch input 1010. However, in addition to the touch input 1010, the input unit 310 may receive user input through a voice input, a gesture input, or a mechanical input.

Referring to FIG. 9, the communication device 400 may generate communication intensity information. The controller 170 may receive the communication intensity information (S920).

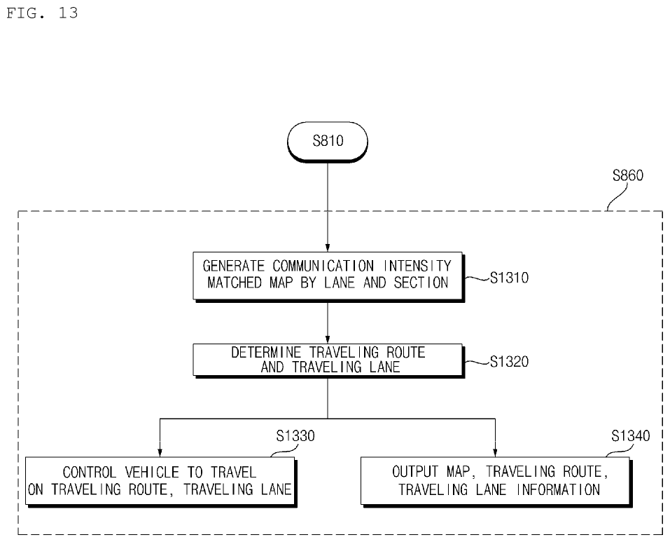

As illustrated in FIG. 11A, the communication device 400 may generate communication intensity information.

The communication device 400 may include a measurement circuit for measuring the communication intensity.

The communication device 400 may measure the intensity of received signal through the measurement circuit and output the intensity of the measured signal as a physical value. For example, the communication device 400 may output the communication intensity as a numerical value.

The communication intensity information may be generated based on the distance between the vehicle 100 and the base station and the direction of the vehicle 100.

The communication device 400 may generate communication intensity information, based on the distance between the vehicle 100 and the base station and the direction of the vehicle 100. Here, the direction of the vehicle 100 may determine the direction of the reception antenna or transmission antenna provided in the communication device 400.

The communication device 400 may generate communication intensity information by a signal path loss calculation scheme.

For example, the communication device 400 may calculate a signal path loss based on Friis Model.

For example, the communication device 400 may calculate the signal path loss based on COST-HATA Model.

Reference numeral 1110 indicates the communication intensity state of a road. As illustrated in 1110 of FIG. 11A, as the vehicle approaches the base station 1101, the communication intensity becomes greater. As the vehicle moves away from the base station 1101, the communication intensity becomes smaller.

Reference numeral 1120 indicates a state in which the communication intensity is digitized for each lane and section of a road. As illustrated in 1120 of FIG. 11A, the road may be divided in a form of lattice, based on lane and section. The section may be a certain range (e.g., 5 m) in the vehicle driving direction.

The communication device 400 may generate the communication intensity information digitized for each lane and section.

Meanwhile, the communication device 400 may receive communication intensity information from an external device. The communication intensity information may be received from the external device via the communication device 400.

Here, the external device may be a nearby vehicle or an infrastructure.

For example, the communication device 400 may receive communication intensity information for each lane and section generated in the nearby vehicle.

For example, the communication device 400 may receive communication intensity information for each lane and section that is built as a data base by integrating communication intensity information acquired through a plurality of vehicles, from the infrastructure.

As illustrated in FIG. 11B, the communication device 400 may measure a communication intensity value by using the measurement circuit and generate communication intensity information (1130). Such a communication intensity information generation model may be referred to as a self-based model.

Alternatively, the communication device 400 may receive the communication intensity value from the external device and generate the communication intensity information (1140). Such a communication intensity information generation model may be referred to as an infra-based model.

Alternatively, the communication device 400 may generate the communication intensity information by using the communication intensity value measured by using the measurement circuit and the communication intensity value received from the external device (1150). Here, the communication device 400 may generate the communication intensity information by using the communication intensity value measured using the measurement circuit and the communication intensity value received from the external device in a manner of assigning a certain weight or obtaining an average value. Such a communication intensity information generation model may be referred to as a hybrid model.

The communication device 400 may generate communication intensity information based on different models, for each section of the road.

For example, in a first section 1151, the communication device 400 may generate communication intensity information based on the self-based model.

For example, in a second section 1152, the communication device 400 may generate communication intensity information based on the infra-based model.

For example, in a third section 1153, the communication device 400 may generate communication intensity information based on the hybrid model.

The communication device 400 may generate communication intensity information based on the type of communication service used by user.

For example, the communication device 400 may generate communication intensity information based on the self-based model when user uses a relatively low-cost first communication service.

For example, the communication device 400 may generate the communication intensity information based on the hybrid model when user uses a relatively high-cost second communication service.

Referring again to FIG. 9, the controller 170 may control to display the communication intensity information (S930). The user interface apparatus 200 may output communication intensity information.

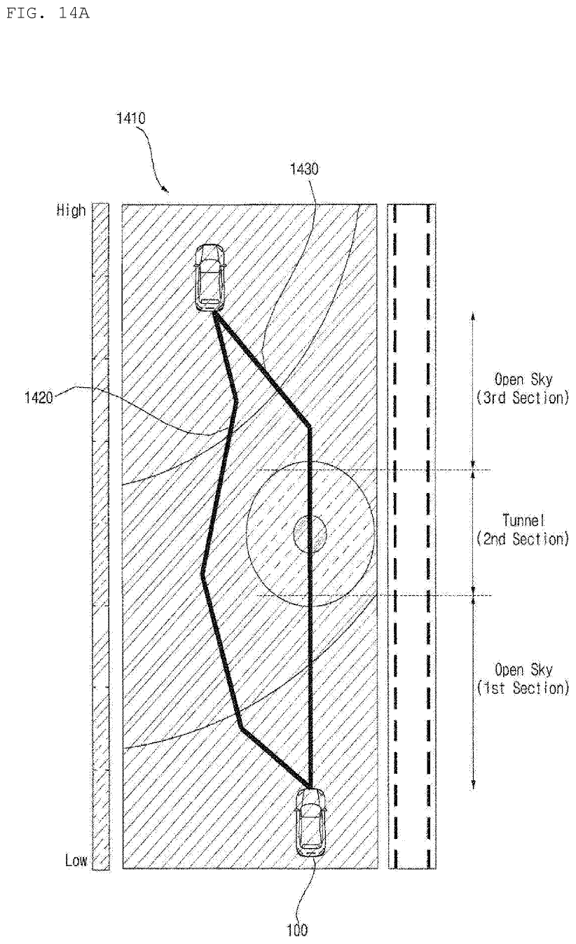

As illustrated in FIG. 12, the user interface apparatus 200 may display communication intensity information.

The user interface apparatus 200 may display communication state information through the display unit 251.

For example, when the communication intensity value is equal to or less than a threshold value so that the communication state is bad, the user interface apparatus 200 may display a shape or text (e.g., BAD) corresponding to the communication state (1210).

For example, when the communication is disconnected, the user interface apparatus 200 may display a shape or text (e.g., DISCONNECT) corresponding to the communication state (S1220).

For example, when the communication intensity value is greater than the threshold value so that the communication state is good, the user interface apparatus 200 may display a shape or text (e.g., GOOD) corresponding to the communication state (S1230).

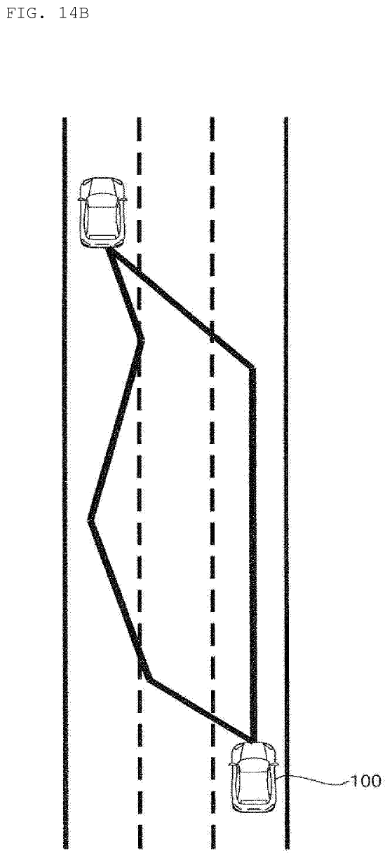

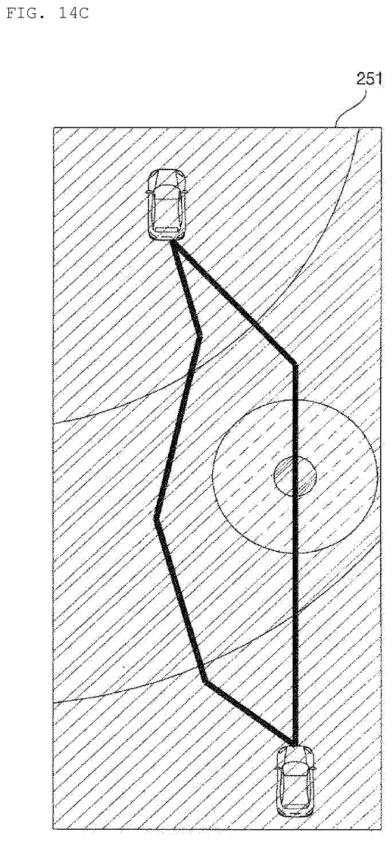

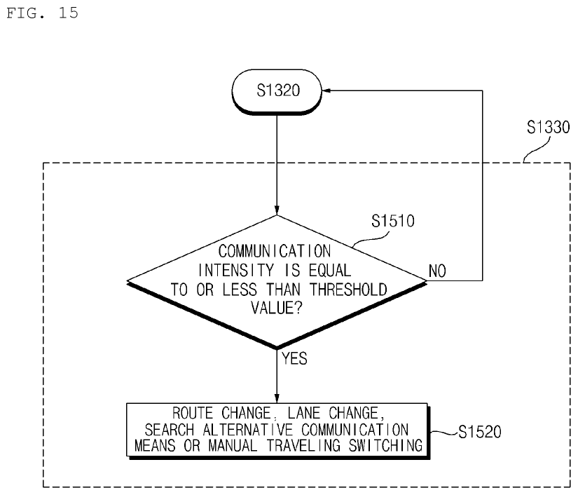

FIGS. 13 to 14C are diagrams for explaining the operation of controlling a vehicle to drive based on communication intensity information according to an embodiment of the present invention.

Referring to the drawings, the step S860 of controlling the vehicle to drive based on the communication intensity information may include a map generating step (S910), a driving lane determining step (S920), a driving control step (S930), and a map and determined driving lane information output step (S940).

The controller 170 may determine the driving route or the driving lane based on the communication intensity information. The controller 170 may control the vehicle 100 to drive on the determined driving route or driving lane.

For example, the controller 170 may generate a map 1410 in which communication intensity is matched for each route, lane, and section based on the communication intensity information (S1310).

Based on the generated map, the controller 170 may determine the route, the lane, and the section having relatively high communication intensity as a route or lane on which the vehicle 100 drives (S1320).

As illustrated in FIG. 14A, the controller 170 may set at least one route or lane 1420 or 1430, based on the map 1410 in which the communication intensity is matched for each route, lane, and section.

The controller 170 may determine the route and lane having relatively high communication intensity among the set route or lane 1420 and 1430 as a route or lane on which the vehicle 100 drives.

For example, a set first route and lane 1420 does not have a communication shadow section on the route, and takes 1 hour and 30 minutes to the destination. In addition, a set second route and lane 1430 has a communication shadow section on the route, and takes 1 hour and 15 minutes to reach the destination. In this case, the controller 170 may determine the first route 1420 as a driving route and lane.

Meanwhile, the route may mean a way through which the vehicle 100 passes by from the departure point to the destination. The lane may mean a lane occupied by the vehicle 100 or to be occupied, among a plurality of lanes on the road corresponding to the route.

The driving lane may be included in the driving route. That is, the driving route may mean a detailed route that takes into account the movement of the vehicle 100 up to the unit of driving lane.

The controller 170 may control the vehicle 100 to drive on the determined driving route or lane (S1330).

As illustrated in FIG. 14B, the controller 170 may control the vehicle drive device 600 so that the vehicle 100 drives on the determined driving route or lane.

More specifically, the controller 170 may controls at least one of the power train drive unit 610, the steering drive unit 621, and the brake drive unit 622 so as to control the driving of the vehicle 100.

The controller 170 may output the map and the determined driving lane information through the user interface apparatus 200 (S1340).

As illustrated in FIG. 14C, the user interface apparatus 200 may output the map and determined driving lane information through the display unit 251.

In this case, the user interface apparatus 200 may output required time information or destination arrival time information, when the vehicle 100 drives according to the set route. The user interface apparatus 200 may output shadow section information located on the route.

Meanwhile, the controller 170 may determine whether there is a communication shadow section on the driving route.

Here, the communication shadow section may mean an area where communication cannot be performed. For example, the communication shadow section may include an underground road section, a tunnel section, and a section having no base station in the vicinity.

Meanwhile, the steps S1330 and S1340 are not in a temporal relationship.

If the driving lane is preset, the controller 170 may change the driving lane based on the communication intensity information, and control the vehicle 100 to drive according to the changed driving lane.

The controller 170 may set a route based on the communication intensity information, and control the vehicle to drive according to the set route.

The controller 170 may output required time information or destination arrival time information through the user interface apparatus 200, when the vehicle drives according to the set route.

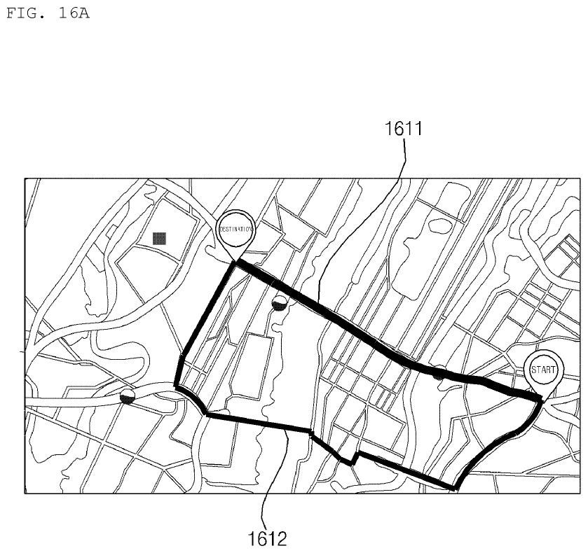

FIGS. 15 to 18 are diagrams for explaining the operation of controlling a vehicle to drive based on communication intensity information according to an embodiment of the present invention.

Referring to the drawing, the step S1330 of controlling the vehicle to drive may include a step S1510 of determining whether the communication intensity is equal to or less than a threshold value, and a step S1520 of changing a route, changing a lane, or switching to a manual driving.

The controller 170 may determine whether the communication intensity value is equal to or less than a threshold value (S1510).

Here, the threshold value may be a reference value on the communication intensity for receiving information, signal, or data from an external device by the communication device 400.

When it is determined that the communication intensity is equal to or less than the threshold value, the controller 170 may perform at least one of a route change operation, a lane setting operation, an alternative communication means search operation, and a manual driving switching operation (S1520).

The controller 170 may determine whether the communication intensity value acquired through the communication device 400 is equal to or less than the threshold value.

The controller 170 may control the vehicle to drive, based on the determination result.

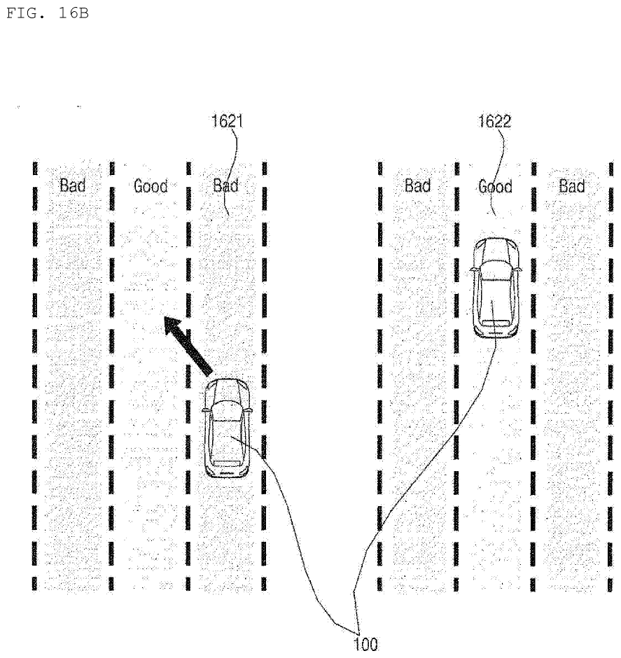

As illustrated in FIG. 16A, in a state where a vehicle route is preset to a first route 1611 and the vehicle 100 is driving according to the preset first route, the controller 170 may determine that the communication intensity value is equal to or less than a threshold value. In this case, the controller 170 may change the vehicle route from the first route 1611 to a second route 1612, and control the vehicle 100 to drive according to the changed second route 1612.

As illustrated in FIG. 16B, in a state where a driving lane is preset to a first lane 1621 and the vehicle 100 is driving according to the preset first lane 1621, the controller 170 may determine that the communication intensity value is equal to or less than a threshold value. In this case, the controller 170 may change the driving lane from the first lane 1621 to a second lane 1622, and control the vehicle 100 to drive according to the changed second lane 1622.

As illustrated in 1630 of FIG. 16C, the controller 170 may control the vehicle interface apparatus 200 to output change information 1631 of the vehicle route.

The user interface apparatus 200 may output the change information 1631 of the vehicle route.

When a user input 1632 for driving according to the changed route is received through the user interface apparatus 200, the controller 170 may control the vehicle 100 to drive according to the changed route.

The user interface apparatus 200 may receive the user input 1632. Here, the user input 1632 may be a user input for a driving command due to the changed route. The controller 170 may receive a signal corresponding to the user input 1632 from the user interface apparatus 200, and control the vehicle 100 to drive according to the changed route.

As illustrated in 1640 of FIG. 16C, the controller 170 may control the vehicle interface apparatus 200 to output lane change information 1641.

The user interface apparatus 200 may output the lane change information 1631.

When a user input 1642 for driving according to the changed lane is received through the user interface apparatus 200, the controller 170 may control the vehicle 100 to drive according to the changed lane.

The user interface apparatus 200 may receive the user input 1642. Here, the user input 1642 may be a user input for a driving command due to the changed lane. The controller 170 may receive a signal corresponding to the user input 1642 from the user interface apparatus 200, and control the vehicle 100 to drive according to the changed route.

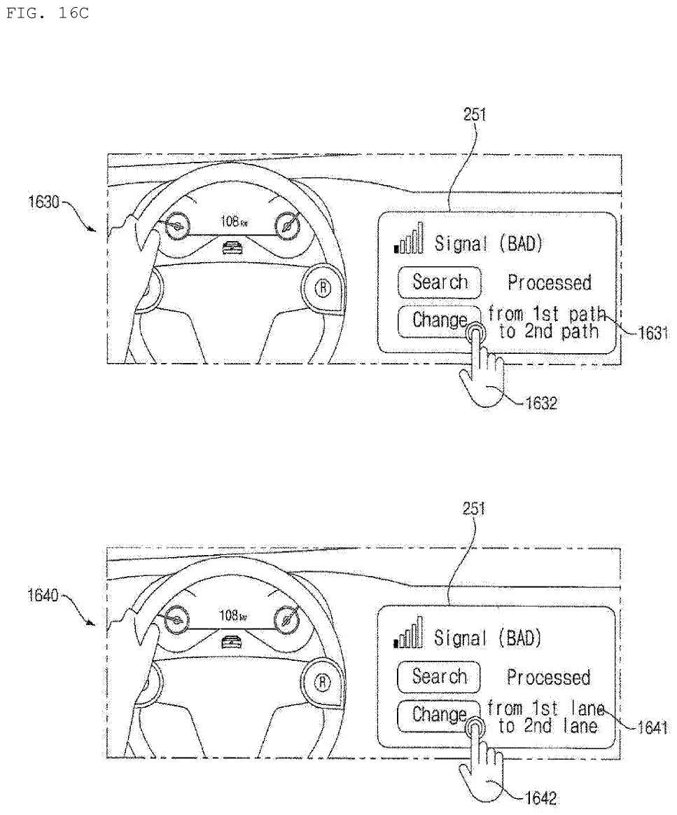

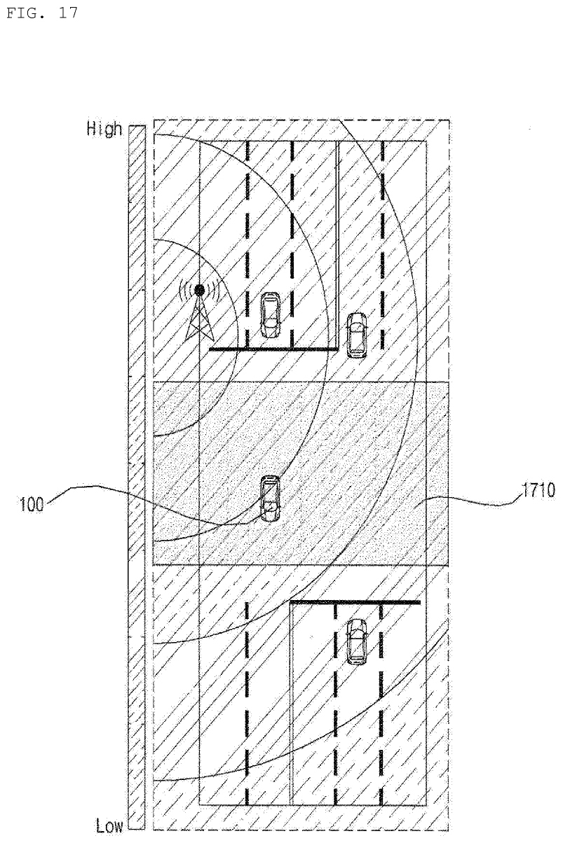

As illustrated in FIG. 17, in a state where the vehicle 100 is driving according to a preset vehicle route, the controller 170 may determine that the communication intensity value is equal to or less than a threshold value. In this case, the controller 170 may control to search alternative communication means.

For example, in a state where the vehicle 100 is driving in a tunnel section 1710 while communicating with an external device through the V2X communication unit 430, when the communication intensity value is determined to be equal to or less than a threshold value, the controller 170 may search the IST communication unit 460 as an alternative communication means. For example, in a state where the vehicle 100 is driving in the tunnel section 1710 while communicating with an external device through the V2X communication unit 430, when the communication intensity value is determined to be equal to or less than a threshold value, the controller 170 may search the short range communication unit 410 and user's mobile terminal as an alternative communication means.

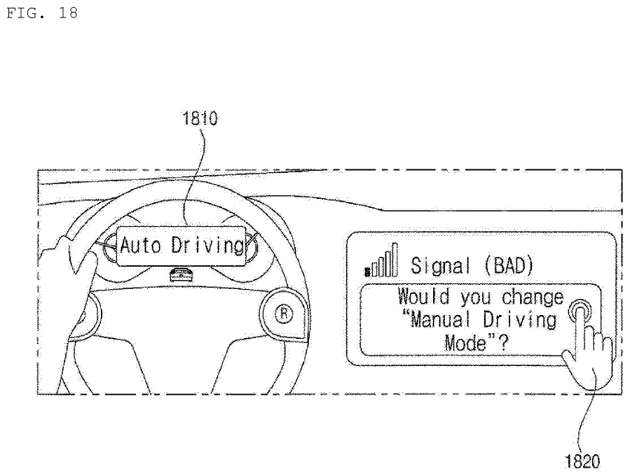

As illustrated in FIG. 18, in a state where the vehicle 100 is driving in an autonomous driving mode 1810, the controller 170 may determine that the communication intensity value is equal to or less than a threshold value. In this case, the controller 170 may control to switch to the manual driving mode.

The controller 170 may control the user interface apparatus 200 to output information of switching to manual driving mode.

The user interface apparatus 200 may output the information of switching to manual driving mode.

The controller 170 may control the driving mode of the vehicle 100 to be switched to the manual driving mode, when a user input 1820 for switching to the manual driving mode is received through the user interface apparatus 200.

The user interface apparatus 200 may receive the user input 1820. Here, the user input 1820 may be a user input for switching the driving mode of the vehicle 100 from the autonomous driving mode to the manual driving mode. The controller 170 may receive, from the user interface apparatus 200, a signal corresponding to the user input. The controller 170 may switch the driving mode from the autonomous driving mode to the manual driving mode. The controller 170 may control the vehicle 100 to drive based on the driving operation of user through the driving manipulation device 500.

Meanwhile, the controller 170 may determine that the communication intensity value is greater than a threshold value, in a state where the vehicle 100 is driving in the manual driving mode. In this case, the controller 170 may control to switch to the autonomous driving mode.

The controller 170 may control the user interface apparatus 200 to output information of switching to autonomous driving mode.

The user interface apparatus 200 may output the information of switching to autonomous driving mode.

The controller 170 may control the driving mode of the vehicle 100 to switch to the autonomous driving mode, when a user input for switching to the autonomous driving mode is received through the user interface apparatus 200.

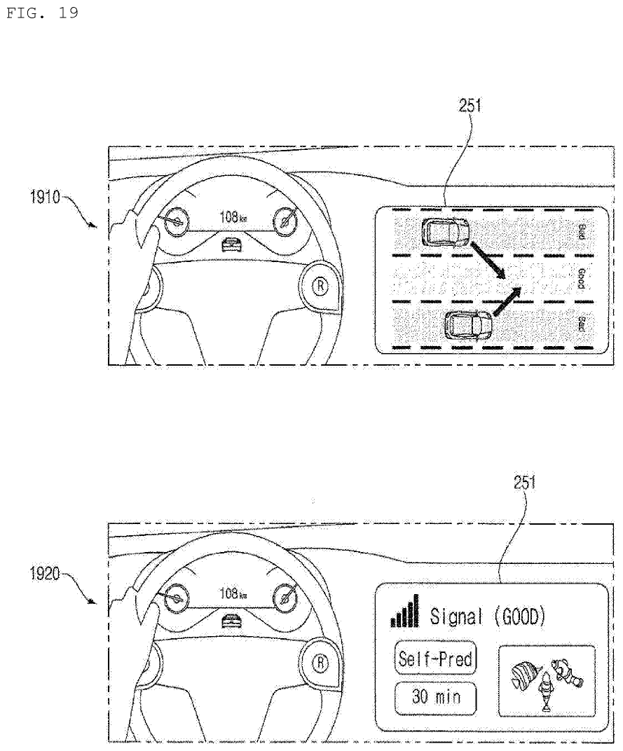

FIG. 19 is a diagram for explaining the operation of controlling a vehicle to drive based on an importance level of information according to an embodiment of the present invention.

Referring to FIG. 19, the controller 170 may control the vehicle 100 to drive based on the importance level of received information, when communicating with an external device.

The importance level of information may be determined by the type of information. The controller 170 may decide the importance level of the information, based on the type of the received information.

For example, the controller 170 may determine that information 1910 related to the driving of the vehicle 100 is more important than information 1920 for entertainment.

The controller 170 may determine the importance level of information, based on the source of the received information. For example, the controller 170 may determine that information received from a traffic-related server is more important than information received from an entertainment server.

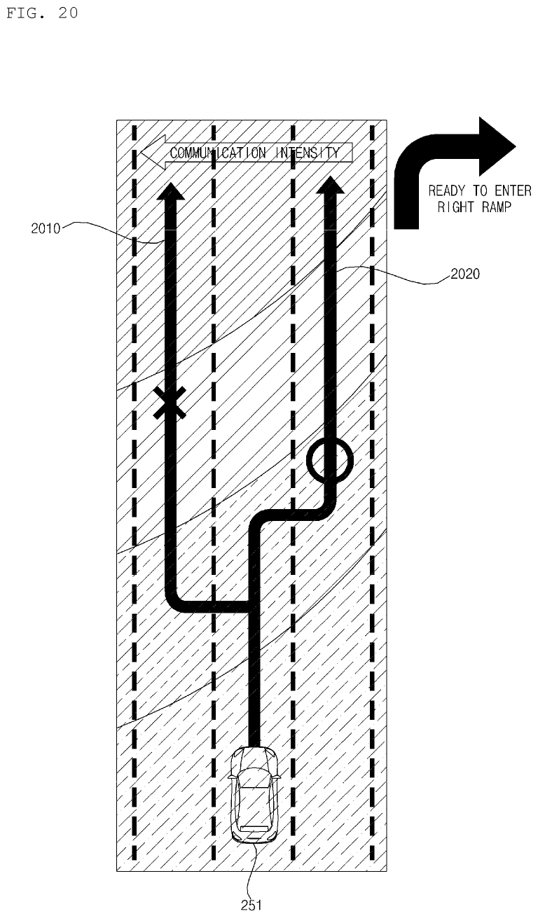

FIG. 20 is a diagram for explaining an exceptional situation of driving based on communication intensity according to an embodiment of the present invention.

Referring to FIG. 20, the controller 170 may control the vehicle 100 to drive, based on the communication intensity information.

In a state in which the vehicle 100 drives based on the communication intensity information, a lane 2010 along a preset driving route of vehicle and a lane 2020 due to the communication intensity may not coincide with each other.

For example, in order for the vehicle 100 to arrive at the destination, it may be required to turn left, turn right, leave the expressway, or enter the expressway. At this time, the lane 2020 based on the communication intensity information and the lane 2010 to be occupied in order to arrive at the destination may not coincide with each other.

In this case, the controller 170 may control the vehicle 100 to drive on the lane 2020 to be occupied in order to arrive at the destination.

The present invention described above can be implemented as computer readable codes on a medium on which a program is recorded. The computer readable medium includes all kinds of recording apparatuses in which data that can be read by a computer system is stored. Examples of the computer readable medium include a hard disk drive (HDD), a solid state disk (SSD), a silicon disk drive (SDD), a ROM, a RAM, a CD-ROM, a magnetic tape, a floppy disk, and may also be implemented in the form of a carrier wave (e.g., transmission over the Internet). In addition, the computer may include a processor or a controller. Accordingly, the above detailed description is to be considered in all respects as illustrative and not restrictive. The scope of the present invention should be determined by rational interpretation of the appended claims, and all changes within the scope of equivalents of the present invention are included in the scope of the present invention.

1. An autonomous vehicle comprising:
a communication device configured to generate communication intensity information when communicating with an external device; and
a controller configured to control the vehicle to drive based on the communication intensity information.

2. The autonomous vehicle of claim 1, further comprising a user interface apparatus configured to receive a user input for driving based on the communication intensity information,
wherein the controller controls the vehicle to drive based on the communication intensity information, when the user input is received.

3. The autonomous vehicle of claim 2, wherein the user interface apparatus outputs the communication intensity information.

4. The autonomous vehicle of claim 1, wherein the controller decides a driving lane, based on the communication intensity information, and controls the vehicle to drive on the decided driving lane.

5. The autonomous vehicle of claim 4, wherein, when the driving lane is preset, the controller changes the driving lane, based on the communication intensity information, and controls the vehicle to drive according to the changed driving lane.

6. The autonomous vehicle of claim 5, wherein the controller generates a map in which communication intensity is matched for each lane and section, based on the communication intensity information, and decides a lane and a section that have a relatively high communication intensity as a driving lane.

7. The autonomous vehicle of claim 6, further comprising a user interface apparatus,
wherein the controller outputs the map and decided driving lane information through the user interface apparatus.

8. The autonomous vehicle of claim 1, wherein the controller sets a route based on the communication intensity information, and controls the vehicle to drive according to the set route.

9. The autonomous vehicle of claim 8, further comprising a user interface apparatus,
wherein the controller outputs required time information or destination arrival time information, when the vehicle drives according to the set route, through the user interface apparatus.

10. The autonomous vehicle of claim 1, wherein the controller determines whether a communication intensity value acquired through the communication device is equal to or less than a threshold value, and controls the vehicle to dive based on a result of the determination.

11. The autonomous vehicle of claim 10, wherein, in a state where a vehicle route is preset and the vehicle is driving according to the preset vehicle route, when the communication intensity value is determined to be equal to or less than the threshold value, the controller changes the vehicle route and controls the vehicle to drive according to the changed route.

12. The autonomous vehicle of claim 11, further comprising a user interface apparatus,
wherein the controller controls to output change information of the vehicle route through the user interface apparatus, and controls the vehicle to drive according to the changed route, when a user input for driving according to the changed route is received through the user interface apparatus.

13. The autonomous vehicle of claim 10, wherein, in a state where the vehicle route is preset and the vehicle is driving according to the preset vehicle route, when the communication intensity value is determined to be equal to or less than the threshold value, the controller controls to search an alternative communication means.

14. The autonomous vehicle of claim 10, wherein, in a state where the vehicle is driving in an autonomous driving mode, when the communication intensity value is determined to be equal to or less than the threshold value, the controller controls to be switched to a manual driving mode.

15. The autonomous vehicle of claim 14, further comprising a user interface apparatus,
wherein the controller controls the user interface unit to output information of switching to the manual driving mode and, when a user input for switching to the manual driving mode is received through the user interface apparatus, controls to be switched to the manual driving mode.

16. The autonomous vehicle of claim 1, wherein the controller controls the vehicle to drive based on an importance level of received information, when communicating with the external device.

17. The autonomous vehicle of claim 16, wherein the controller decides the importance level, based on a type of the received information.

18. The autonomous vehicle of claim 1, wherein the communication intensity information is acquired based on a distance between the vehicle and a base station and a direction of the vehicle.

19. The autonomous vehicle of claim 1, wherein the communication intensity information is received from the external device through the communication device.

20. An operating method for an autonomous vehicle, the method comprising:
acquiring communication intensity information through a communication device, when communicating with an external device;
generating a map in which communication intensity is matched for each lane and section, based on the communication intensity information;
deciding a driving lane by using a lane and a section that have a relatively large communication intensity; and
outputting the map and information on decided driving lane through a user interface apparatus.
